(19) United States
(12) Patent Application Publication
(10) Pub. No.: US 2020/0063706 A1
(43) Pub. Date: Feb. 27, 2020

(54) HYDROELECTRIC POWER GENERATION DEVICE USING MULTISTAGE CASCADE STRUCTURE

(71) Applicant: Jungchi PARK, Mungyeong (KR)

(72) Inventor: Jungchi PARK, Mungyeong (KR)

(21) Appl. No.: 16/462,875

(22) PCT Filed: Nov. 17, 2017
(86) PCT No.: PCT/KR2017/013076

§ 371 Date: May 21, 2019

(30) Foreign Application Priority Data
Nov. 22, 2016 (KR) 10-2016-0155584

(51) Int. Cl. F03B 7/00; H02K 7/18; H02K 11/00; F03B 13/06

(52) U.S. Cl. CPC F03B 7/00; F03B 13/06; H02K 11/0094; H02K 7/1823

(57) ABSTRACT

The present invention relates to a hydroelectric power generation device using a multistage cascade structure. The hydroelectric power generation device includes: a support (10) having a predetermined length and installed in a vertical direction; a plurality of waterwheels (20) each including a horizontal axle (21) rotatably installed on the support (10) and a plurality of buckets (22) radially arranged around the axle (21); upper and lower water tanks (30, 40) respectively installed on upper and lower portions of the support (10) and respectively containing predetermined amounts of water; a pump (50) installed in the lower water tank (40) to supply water from the lower water tank (40) to the upper water tank (30); generators (60) respectively installed on the axles (21) of the waterwheels (20); and a charging battery (70) configured to store electricity produced by the generators (60). Thus, according to the present invention, electricity can be stably and effectively produced.

### TECHNICAL FIELD

The present invention relates to a hydroelectric power generation device using a multistage cascade structure, and more particularly, to a hydroelectric power generation device using a multistage cascade structure in which a plurality of waterwheels are vertically installed to operate generators and thus produce electricity while the waterwheels are rotated by water falling by gravity along the waterwheels.

### BACKGROUND ART

In general, various methods for producing electricity using thermal power, water power, wind power, solar power, and the like have been known, and devices for producing electricity by using water power (hereinafter referred to as hydroelectric power generation devices) have been widely used because they produce low environmental pollution and have a simple structure.

In general, such hydroelectric power generation devices have a structure in which rotation power generated as a waterwheel is rotated by water falling by gravity is used to operate a generator to produce electricity.

An example of a hydroelectric power generation device using a waterwheel is disclosed in Korean Patent No. 1272607, entitled “water collecting apparatus of electric power generating system using water mill.” In the hydroelectric power generation device disclosed in the patent document, waterwheels are vertically arranged in multiple stages, and as water continuously falls along the vertically arranged waterwheels, the waterwheels are rotated. In the disclosed hydroelectric power generation device, since a plurality of small waterwheels are installed, the waterwheels may be properly arranged according to the distance water falls.

However, in the disclosed hydroelectric power generation device, it is difficult to increase the distance water falls to each waterwheel because a plurality of small waterwheels are used, and thus the waterwheels are rotated by low power.

Moreover, since the waterwheels arranged in multiple stages are connected to a single driving shaft through gears to rotate the driving shaft, it is difficult to rotate the driving shaft only by the uppermost waterwheel when the driving shaft is initially rotated. Thus, the uppermost waterwheel is not smoothly rotated, and loads on the other lower waterwheels increase. Therefore, in general, the waterwheels are not easily rotated.

Therefore, a device such as a motor has to be used to provide rotation power to easily rotate the waterwheels or the driving shaft when initially rotating the waterwheels or the driving shaft, and moreover, a device such as a pump has to be used to continuously supply water to the uppermost waterwheel so as to continuously rotate the waterwheels. Therefore, electricity is consumed to operate devices such as a motor and a pump, and the efficiency of power generation of a generator is affected. That is, the efficiency of power generation is low.

Therefore, what is needed is a highly efficient hydroelectric power generation device configured to easily rotate waterwheels without power provided by a device such as a motor when initially rotating the waterwheels and to continuously rotate the waterwheels without continuously operating a pump.

### DESCRIPTION OF EMBODIMENTS

### Technical Problem

Accordingly, the present invention is proposed to solve the above-described problems of electric power generation devices having a multistage waterwheel structure of the related art, and an object of the present invention is to provide a hydroelectric power generation device having a multistage cascade structure in which waterwheels can be easily rotated without using a motor when the waterwheels are initially rotated and electricity can be continuously produced without continuously operating a pump.

### Solution to Problem

The object of the present invention is achieved by a hydroelectric power generation device using a multistage cascade structure, the hydroelectric power generation device including: a support having a predetermined length and installed in a vertical direction; a plurality of waterwheels each including a horizontal axle rotatably installed on the support and a plurality of buckets radially arranged around the axle; an upper water tank and a lower water tank that are respectively installed on an upper portion and lower portion of the support and respectively contain predetermined amounts of water; a pump installed in the lower water tank to supply water contained in the lower water tank to the upper water tank; generators respectively installed on the axles of the plurality of waterwheels; and a charging battery configured to store electricity produced by the generators.

In addition, the present invention is characterized in that: a pair of water level sensors are installed at the upper water tank; and an operation of the pump is controlled such that a predetermined amount of water is maintained in the upper water tank based on information about a highest water level and a lowest water level detected by the pair of water level sensors.

In addition, the present invention is characterized in that water collectors are installed between the plurality of waterwheels at opposite sides to guide water falling and passing through the plurality of waterwheels.

In addition, the present invention is characterized in that pulleys or sprockets are respectively installed on the axles of the plurality of waterwheels and axles of the generators, and the pulleys or the sprockets interact with each other through V-belts or chains.

### Advantageous Effects of Disclosure

According to the present invention, since the plurality of waterwheels are independently operated while respectively interacting with the generators, electricity can be stably produced while the plurality of waterwheels are independently rotated. In addition, electricity necessary for operating the pump can be saved because the pump is controlled in such a manner that after water is supplied from the lower water tank to the upper water tank to a predetermined water level, the pump is intermittently operated to supply water to the upper water tank according to results of detection of the water level sensors.

In addition, according to the present invention, the axles of the generators are rotated at a relatively high speed according to the diameter difference between the pulleys installed on the axles of the waterwheels and the generators or the gear ratio of the sprockets installed on the axles of the waterwheels and the generators, and thus rotation power sufficient for generating electricity can be obtained without using additional multiplying gear sets. Therefore, the hydroelectric power generation device may have a simple installation structure.

In addition, according to the present invention, owing to water-converging portions formed by cutting lower end portions of water collectors in a V-shape, when water falls to a lower waterwheel to rotate the lower waterwheel after the water rotates an upper waterwheel and is collected in a water collector, the water can be converged by the V-shaped water-converging portion of the water collector. Therefore, loss caused by diverging water may be minimized.

### BRIEF DESCRIPTION OF DRAWINGS

FIG. 1 is a view illustrating an example configuration of a hydroelectric power generation device using a multistage cascade structure according to the present invention.

FIG. 2 is a perspective view illustrating an example of a waterwheel according to the present invention.

FIG. 3 is a perspective view illustrating an example of a water collector according to the present invention.

FIG. 4 is a view illustrating an example operation of the hydroelectric power generation device using a multistage cascade structure according to the present invention.

<Descriptions of reference numerals>

| | |
|---|---|
| 10: Support | 20, 20A, 20B, 20C: Waterwheels |
| 21: Axles | 22: Buckets |
| 23: Water collectors | 23A: water-conversing portions |
| 24: Pulleys | 30: Upper water tank |
| 31, 32: Water level sensors | 40: Lower water tank |
| 50: Pump | 51: Water supply pipe |
| 60: Generators | 61: Axles |
| 62: Pulleys | 70: Charging battery |
| B: V-belts | |

### MODE OF DISCLOSURE

Hereinafter, the configuration and operation of the present invention will be described in more detail according to preferred embodiments with reference to the accompanying drawings.

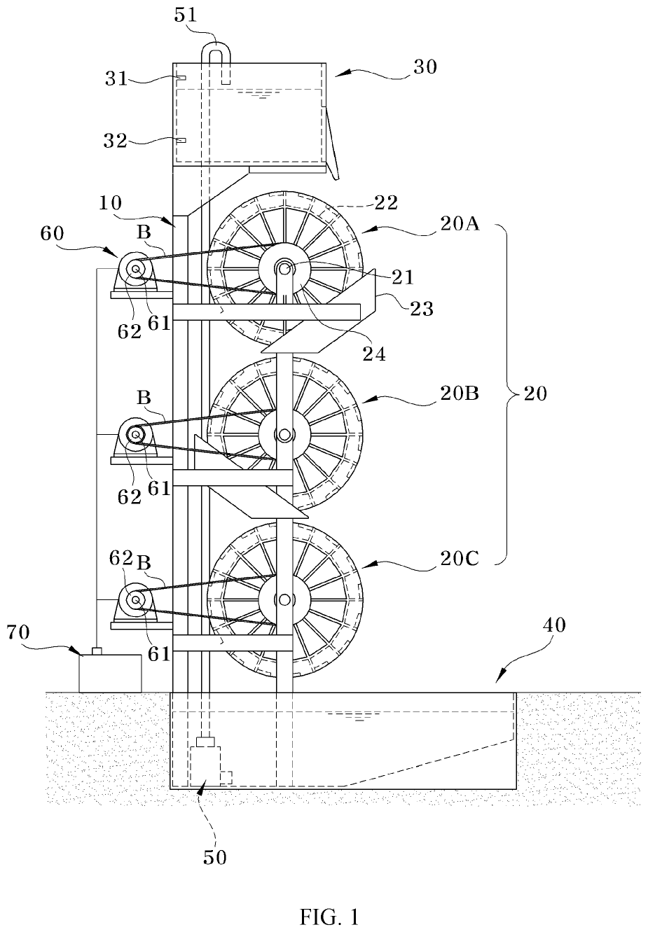

The present invention provides a hydroelectric power generation device using a multistage cascade structure in which waterwheels are installed in multiple stages in such a manner that the waterwheels can be easily rotated without using a device such as a motor when being initially rotated, and power can be continuously generated without having to continuously operate a pump. To this end, as shown in FIG. 1, the hydroelectric power generation device of the present invention includes a support 10, waterwheels 20, an upper water tank 30, a lower water tank 40, a pump 50, generators 60, and a charging battery 70.

The support 10 is a frame which is formed of a material such as wood or a metal and is set up on the ground to a certain height. The upper water tank 30 is installed on an upper portion of the support 10 to supply water to the uppermost waterwheel 20, the plurality of waterwheels 20 are vertically arranged along the support 10, and the plurality of generators 60 are installed corresponding to the waterwheels 20.

The plurality of waterwheels 20 are installed on the support 10 at regular intervals in a vertical direction, and as water supplied from the upper water tank 30 falls sequentially along the plurality of waterwheels 20 from an upper waterwheel 20 to a lower waterwheel 20, each waterwheel 20 is rotated, thereby producing rotation power and generating electricity by operating the generators 60 with the rotation power.

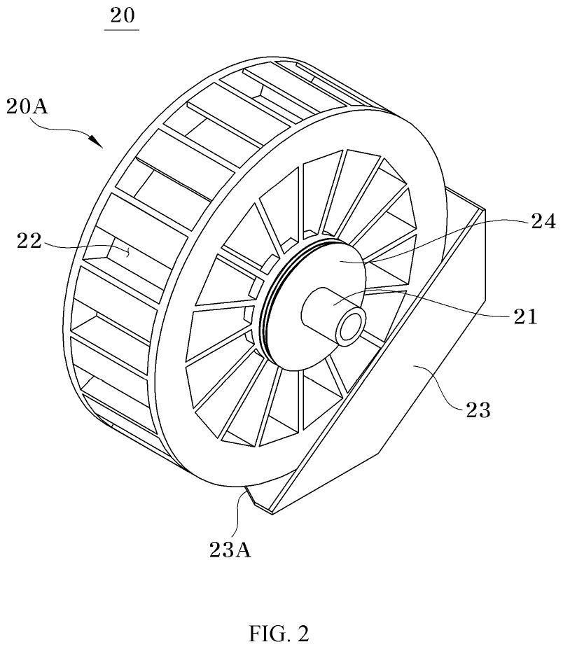

As shown in FIGS. 1 and 2, each of the plurality of waterwheels 20 includes a horizontal axle 21, and connection spokes (not denoted with a reference numeral) having a certain length are radially provided around the horizontal axle 21. Buckets 22 are radially arranged along the connection spokes, and the waterwheels 20 is rotated by force generated by water colliding with the buckets 22 as falling into and out of the buckets 22.

In addition, pulleys 24 or sprockets are provided on the axles 21 of the waterwheels 20 and are connected to pulleys 62 or sprockets (described later) provided on axles 61 of the generators 60 through belts B or chains such that the generators 60 can be operated as the waterwheels 20 are rotated.

In addition, water collectors 23 are installed between the waterwheels 20 in such a manner that each collector 23 covers a lower side and a lateral side of an upper waterwheel 20, and vertically adjacent water collectors 23 are located at opposite sides to rotate vertically adjacent waterwheels 20 in opposite directions.

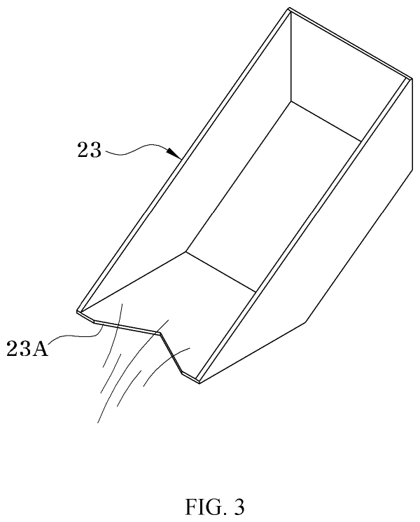

In addition, as shown in FIG. 3, a water-converging portion 23A is formed on each water collector 23 by cutting an end of the water collector 23 in a V-shape such that when water collected in the water collector 23 falls to a lower waterwheel 20, the water converges as passing through the water-converging portion 23A. Therefore, loss caused by diverging water may be minimized.

The upper water tank 30 containing a certain amount of water is installed on the upper portion of the support 10. A certain amount of water contained in the lower water tank 40 (described later) is supplied to the upper water tank 30 using the pump 50, and then the water is supplied to the uppermost waterwheel 20. Thus, although the pump 50 is not continuously operated, the waterwheels 20 may be continuously rotated to continuously operate the generators 60 and thus to continuously generate electricity.

The upper water tank 30 is manufactured to have a tetragonal box shape with an open upper side, water level sensors 31 and 32 respectively configured to detect the lowest water level and the highest water level are installed inside the upper water tank 30, and a water supply pipe (not denoted with a reference numeral) communicating with the inside of the upper water tank 30 is provided in a lower side of the upper water tank 30 to guide water falling along a side of the axle 21 of the uppermost waterwheel 20.

In addition, if it rains, rainwater is stored in the upper water tank 30 through the open upper side of the upper water tank 30, and thus since it is not necessary to operate the pump 50 to supply water to the upper water tank 30, electrical energy is saved.

To this end, according to the present invention, the upper water tank 30 is formed to have an upper circumference greater than a lower circumference thereof so as to more effectively collect rainwater in the upper water tank 30, and since a water collecting area increases, a more amount of rainwater may be rapidly collected for a given period of time.

The lower water tank 40 is installed on the lower portion of the support 10, and water is circulated by collecting water falling after rotating the plurality of waterwheels 20 in the lower water tank 40 and then supplying the water to the upper water tank 30 using the pump 50.

The capacity of the lower water tank 40 is two to four times the capacity of the upper water tank 30, and thus a sufficient amount of water may remain in the lower water tank 40 even after water is supplied from the lower water tank 40 to the upper water tank 30 to reach the highest water level of the upper water tank 30. therefore, power generation may be stably continued even if some water loss occurs. In addition, the pump 50 may be maintained under water without being exposed to the outside of water, and thus water may be stably supplied to the upper water tank 30.

The pump 50 is installed in the lower water tank 40 to supply water from the lower water tank 40 to the upper water tank 30. The pump 50 is a submersible pump placed on the bottom of the lower water tank 40 and immersed in water. In this case, a net-type filter (not shown) may be provided on an water inlet (not denoted with a reference numeral) of the pump 50 to prevent foreign substances from entering into the pump 50, and a water supply pipe 51 connected to the upper water tank 30 may be installed on a water outlet (not denoted with a reference numeral) of the pump 50.

The plurality of generators 60 are installed along a side of the support 10 in an interacting relationship with the plurality of waterwheels 20, and as the waterwheels 20 are rotated, the generators 60 are rotated together with the waterwheels 20, thereby generating electricity.

In this case, pulleys 62 or sprockets having a smaller diameter or fewer teeth than the pulleys 24 or sprockets provided on the axles 21 of the waterwheels 20 are provided on the axles 61 of the generators 60, and V-belts or chains are provided around the pulleys 24 and 62 or the sprockets. Therefore, although a multiplying gear set is not installed, as the waterwheels 20 are rotated, the axles 61 of the generators 60 may be rotated at a higher speed than the axles 21 of the waterwheels 20, and thus rotation power necessary for power generation may be obtained.

The charging battery 70 is installed at a lower side of the support 10 and is charged with electricity produced by the plurality of generator 60. In this case, a plurality of charging batteries 70 may be provided, and power lines may be connected such that one of the charging batteries 70 may supply electricity to the pump 50 and the water level sensors 31 and 32.

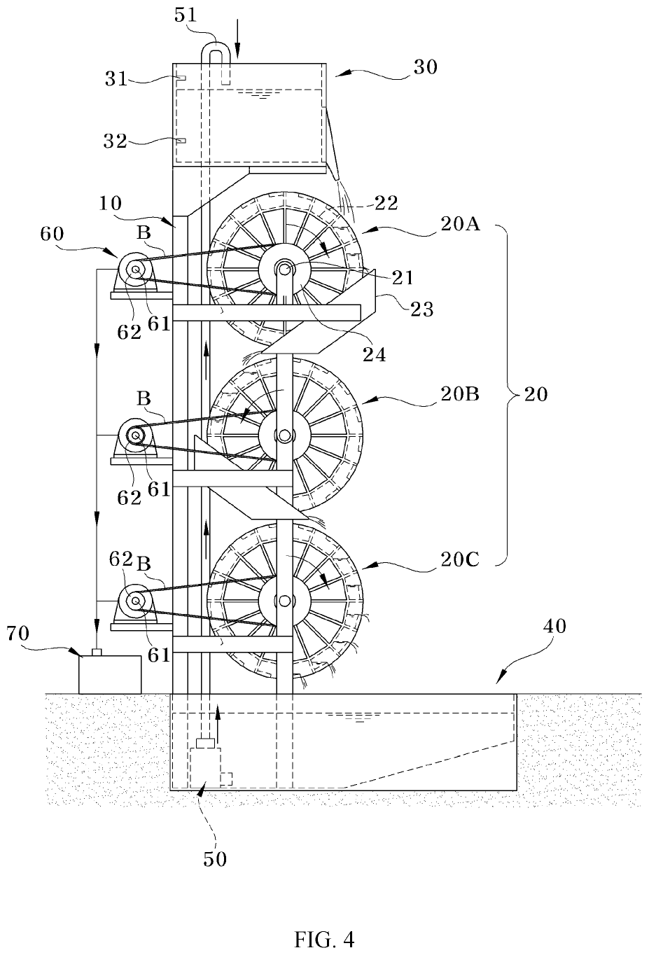

As shown in FIG. 4, when the hydroelectric power generation device using the multistage cascade structure of the present invention is used, water stored in the lower water tank 40 is supplied to the upper water tank 30 by operating the pump 50, and at the same time, water of the upper water tank 30 falls to the uppermost waterwheel 20A through the water supply pipe at a constant speed. Then, the uppermost waterwheel 20A is rotated, and the generator 60 connected to the uppermost waterwheel 20A through the V-belt B or chain is operated, thereby producing electricity.

The water used to rotate the uppermost waterwheel 20A is collected in the water collector 23 and is sequentially supplied to the other waterwheels 20B and 20C arranged below the uppermost waterwheel 20A, and thus the waterwheels 20B and 20C are rotated. Then, the generators 60 respectively connected to the waterwheels 20B and 20C are operated, and electricity is produced. After rotating the lowermost waterwheel 20C, the water is collected and stored in the lower water tank 40.

In addition, if a water level detection signal is generated from the water level sensor 32 configured to detect the highest water level while the pump 50 supplies water from the lower water tank 40 to the upper water tank 30, the pump 50 is stopped, and then if a water level detection signal is generated from the water level sensor 31 configured to detect the lowest water level, the pump 50 is operated again to supply water to the upper water tank 30. Owing to this structure, the level of water in the upper water tank 30 is maintained at least at the lowest water level, and the waterwheels 20A, 20B, and 20C, and the generators 60 are continuously operated, thereby stably producing electricity.

As described above, according to the present invention, the waterwheels 20 can be easily rotated without using a device such as a motor when the waterwheels 20 are initially rotated, and electricity can be stably generated without continuously operating the pump 50.

1. A hydroelectric power generation device using a multistage cascade structure, the hydroelectric power generation device comprising:
a support (10) having a predetermined length and installed in a vertical direction;
a plurality of waterwheels (20) each comprising a horizontal axle (21) rotatably installed on the support (10) and a plurality of buckets (22) radially arranged around the axle (21);
an upper water tank (30) and a lower water tank (40) that are respectively installed on an upper portion and lower portion of the support (10) and respectively contain predetermined amounts of water;
a pump (50) installed in the lower water tank (40) to supply water contained in the lower water tank (40) to the upper water tank (30);
generators (60) respectively installed on the axles (21) of the plurality of waterwheels (20); and
a charging battery (70) configured to store electricity produced by the generators (60).

2. The hydroelectric power generation device of claim 1, wherein a pair of water level sensors (31, 32) are installed at the upper water tank (30), and an operation of the pump (50) is controlled such that a predetermined amount of water is maintained in the upper water tank (30) based on information about a highest water level and a lowest water level detected by the pair of water level sensors (31, 32).

3. The hydroelectric power generation device of claim 1 or 2, wherein water collectors (23) are installed between the plurality of waterwheels (20) at opposite sides to guide water falling and passing through the plurality of waterwheels (20).

4. The hydroelectric power generation device of claim 1 or 2, wherein pulleys (24, 62) or sprockets are respectively installed on the axles (21) of the plurality of waterwheels (20) and axles (61) of the generators (60), and the pulleys (24, 62) or the sprockets interact with each other through V-belts (B) or chains.
